(19) United States
(12) Patent Application Publication
(10) Pub. No.: US 2025/0161957 A1
(43) Pub. Date: May 22, 2025

(54) VORTEX MINERALIZATION-STATIC SEPARATION FLOTATION DEVICE AND FLOTATION METHOD

(71) Applicants: CHINA UNIVERSITY OF MINING AND TECHNOLOGY, Xuzhou (CN); SHANXI ZHONGBODA CONSTRUCTION CO., LTD., Jincheng (CN)

(72) Inventors: Haijun ZHANG, Xuzhou (CN); Yubing HUO, Jincheng (CN); Hainan WANG, Xuzhou (CN); Xiaokang YAN, Xuzhou (CN); Quanzhi TIAN, Xuzhou (CN); Yanlin QIU, Jincheng (CN); Lijun WANG, Xuzhou (CN); Danlong LI, Xuzhou (CN)

(73) Assignees: CHINA UNIVERSITY OF MINING AND TECHNOLOGY, Xuzhou (CN); SHANXI ZHONGBODA CONSTRUCTION CO., LTD., Jincheng (CN)

(21) Appl. No.: 19/031,986

(22) Filed: Jan. 18, 2025

Related U.S. Application Data
(63) Continuation-in-part of application No. PCT/CN2024/114848, filed on Aug. 27, 2024.

(30) Foreign Application Priority Data
Oct. 26, 2023 (CN) 202311403204.5

(51) Int. Cl. B03D 1/14; B03D 1/02; B03D 1/08; C22B 1/00

(52) U.S. Cl. CPC B03D 1/1425; B03D 1/025; B03D 1/085; B03D 1/1456; B03D 1/1468; C22B 1/00; B03D 2203/02

(57) ABSTRACT

Disclosed is a vortex mineralization-static separation flotation device and a flotation method. The device comprises: a static separator provided with a separation chamber and a vortex mineralizer provided with a mineralization cylinder. The separation chamber includes a raw ore treatment pipeline and an intermediate ore treatment pipeline. The mineralization cylinder includes a vortex mineralization pipeline. The method comprises: the mineralization cylinder being full of a raw ore slurry and the raw ore slurry in the separation chamber reaching a set level, turning on air conduits and an agitation device to make air enter the mineralization cylinder and form tiny bubbles to collide with first mineral particles and mineralize to form an aerated intermediate ore slurry; the aerated intermediate ore slurry entering the separation chamber and performing collision and mineralization with second mineral particles and the raw ore slurry, and concentrate froth being formed at a top of the separation chamber to be collected.

### CROSS-REFERENCE TO RELATED APPLICATIONS

The application is a Continuation-in-part of International Patent Application No. PCT/CN2024/114848, filed on Aug. 27, 2024, which claims priority to Chinese Patent Application No. 202311403204.5, filed on Oct. 26, 2023, the entire contents of which are incorporated herein by reference.

### TECHNICAL FIELD

The present disclosure relates to the technical field of mineral flotation, and in particular to a vortex mineralization-static separation flotation device and a flotation method.

### BACKGROUND

Difficulty in the effective recovery of fine-grained minerals is the main reason that restricts the improvement of the recovery rate of separation of low-quality mineral resources. Flotation is the current main method of processing fine-grained minerals, which realizes the separation of useful minerals and pulsatile minerals in a complex gas-liquid-solid three-phase system using air bubbles as carriers based on the surface hydrophobicity difference of the mineral particles. In the flotation process, the mineral particles and the bubbles are fully dispersed and collide with each other under the action of the fluid. Hydrophobic particles adhere to the surface of the bubbles, and form a foam layer as the bubbles float upward, and are collected for obtaining concentrates. Hydrophilic particles are difficult to adhere to the surface of the bubbles and are left in the flotation tank as tailings.

In the mineral flotation mineralization process, the mineral physical properties and floatability characteristics present a non-linear relationship, i.e., microfine particles and coarse particles are difficult to float, and medium-sized particles are easy to float; weakly hydrophobic particles are difficult to float, and strongly hydrophobic particles are easy to float. The scientific reason is that microfine particles are easily affected by the fluid streamlines during the collision process, and lack sufficient gravity and inertial force to break through the fluid streamlines and collide with the bubbles; the coarse particles, due to the large mass and kinetic energy, slide fast on the surface of the bubbles and are difficult to adhere to the surface of the bubbles due to the short contact time, prone to desorption by an external force; the weakly hydrophobic particles, due to the small hydrophobic force, are difficult to break through the liquid membrane between the bubbles and the particles to adhere, and are easily desorbed under the influence of the fluid as the weak adhesion.

A large number of studies have shown that there is a fluid scale effect in the flotation mineralization process, i.e., the stronger the turbulence, the stronger the turbulence dissipation, and the smaller the turbulence vortex scale in a certain range, the more conducive to forcing the microfine particles to break through the fluid streamlines to collide with the bubbles, and the higher the probability of mineralization of the microfine particles. However, if the turbulence is too strong, the probability of adhesion of the coarse particles is greatly reduced, and the probability of desorption is greatly increased, resulting in a decrease in the probability of mineralization. For weakly hydrophobic particles, a relatively gentle flow field environment is more conducive to strengthening the mineralization process. In addition, the fluid scale also has a significant effect on the separation process. The gentle fluid environment generates large-scale vortexes, which facilitate the stable upward recovery of mineralized bubbles. Because of different turbulence requirements of particles with different physical properties for the flotation process, and different turbulence field characteristics that need to be adapted to the mineralization process and the separation process, it is currently difficult to achieve efficient mineralization-separation and recovery of mineral particles of all physical properties in the same flotation process.

Therefore, it is desirable to provide a vortex mineralization-static separation flotation device and a flotation method, in which the mineralization process is separated from a conventional flotation process to be further strengthened, and a flotation device with a reasonable fluid scale distribution is provided, so as to achieve the reasonable distribution of turbulence energy in the flotation process to strengthen the separation flotation recovery of particles with different physical properties.

### SUMMARY

One or more embodiments of the present disclosure provide a vortex mineralization-static separation flotation device. The vortex mineralization-static separation flotation device may comprise a static separator provided with a separation chamber and a vortex mineralizer provided with a mineralization cylinder. The separation chamber may be provided with a raw ore treatment pipeline from top to bottom and an intermediate ore treatment pipeline from bottom to top. The mineralization cylinder may be provided with a vortex mineralization pipeline from bottom to top. A first outlet of the raw ore treatment pipeline may be connected with a second inlet of the vortex mineralization pipeline. A second outlet of the vortex mineralization pipeline may be connected with a third inlet of the intermediate ore treatment pipeline.

One or more embodiments of the present disclosure provide a vortex mineralization-static separation flotation method. The vortex mineralization-static separation flotation method may comprise:
S1. Closing a tailings discharge pipe disposed at a bottom of a separation chamber, a raw ore slurry entering the separation chamber from a first inlet of a raw ore treatment pipeline and being discharged through a first outlet, the raw ore slurry entering a mineralization cylinder from a second inlet of a vortex mineralization pipeline, and when the mineralization cylinder is full of the raw ore slurry, the raw ore slurry being discharged from a second outlet of the vortex mineralization pipeline and entering the separation chamber again from a third inlet of an intermediate ore treatment pipeline;
S2. in response to determining that the raw ore slurry in the separation chamber reaches a set level, turning on one or more air conduits, an agitation device, and the tailings discharge pipe to make air enter the mineralization cylinder and form tiny bubbles to collide with first mineral particles and mineralize to form an aerated intermediate ore slurry;
S3. the aerated intermediate ore slurry entering the separation chamber through the third inlet of the intermediate ore treatment pipeline, the tiny bubbles being released to collide with second mineral particles in the separation chamber to mineralize, low-density mineralized bubbles moving towards a center of the separation chamber and floating upwardly, unmineralized bubbles descending, and the low-density mineralized bubbles performing countercurrent collision and mineralization with the raw ore slurry entering the separation chamber;
S4. low-density unmineralized minerals in a middle region of the separation chamber being discharged as an intermediate ore slurry through the first outlet of the raw ore treatment pipeline, high-density unmineralized minerals in a surrounding region of the separation chamber forming tailings to be discharged through the tailings discharge pipe, repeating S1-S3, the mineralized bubbles continuing to form stable concentrate froth at a top of the separation chamber, and the concentrate froth overflowing and being collected;
S5. after separation flotation is completed, stopping feeding of the first inlet of the raw ore treatment pipeline, closing the tailings discharge pipe, turning off a power device, and opening an ore discharge pipe to discharge a residual slurry in the separation chamber and the mineralization cylinder, in response to determining that a liquid level in the mineralization cylinder is lower than an inlet height of each of the one or more air conduits, closing the one or more air conduits, turning off a circulation pump after the residual slurry in the separation chamber is discharged completely, and closing the ore discharge pipe after all discharges are completed.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic structural diagram illustrating an exemplary vortex mineralization-static separation flotation device according to some embodiments of the present disclosure;

FIG. 2 is a schematic structural diagram illustrating an exemplary inlet pipeline according to some embodiments of the present disclosure;

FIG. 3 is a schematic structural diagram illustrating an exemplary mineralization impeller according to some embodiments of the present disclosure;

FIG. 4 is a schematic structural diagram illustrating an exemplary sieve plate according to some embodiments of the present disclosure;

FIG. 5 is a schematic structural diagram illustrating an exemplary dispersion circulation impeller according to some embodiments of the present disclosure;

FIG. 6 is a schematic structural diagram illustrating another exemplary inlet pipeline according to some embodiments of the present disclosure;

FIG. 7 is a schematic diagram illustrating an exemplary process of separation flotation according to some embodiments of the present disclosure;

FIG. 8 is a schematic diagram illustrating an exemplary control model according to some embodiments of the present disclosure; and

FIG. 9 is a schematic diagram illustrating an exemplary prediction model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

It should be understood that the terms “first,” “second,” or the like, as used in the specification and the claims of the present disclosure, do not indicate any order or importance, but are used only to distinguish different components. Similarly, the terms “a” or “one,” or the like do not indicate a quantitative limitation, but rather indicate the presence of at least one. Unless otherwise noted, “anterior,” “posterior,” “lower,” and/or “upper” and similar terms are used for illustrative purposes only and are not limited to a location or spatial orientation. The terms “including” or “comprising” or the like indicate that the elements or objects appearing before “including” or “comprising” include the elements or objects listed after “including” or “comprising” and their equivalents, and do not exclude other elements or objects.

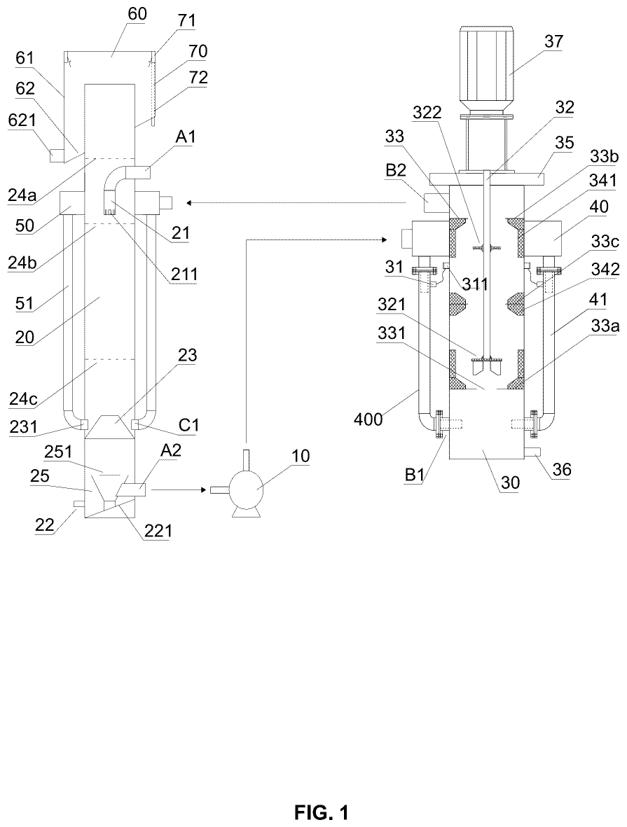

FIG. 1 is a schematic structural diagram illustrating an exemplary vortex mineralization-static separation flotation device according to some embodiments of the present disclosure.

In some embodiments, as shown in FIG. 1, the vortex mineralization-static separation flotation device may include a static separator provided with a separation chamber 20 and a vortex mineralizer provided with a mineralization cylinder. The separation chamber 20 may be provided with a raw ore treatment pipeline from top to bottom and an intermediate ore treatment pipeline from bottom to top. The mineralization cylinder 30 may be provided with a vortex mineralization pipeline from bottom to top. A first outlet A2 of the raw ore treatment pipeline may be connected with a second inlet B1 of the vortex mineralization pipeline. A second outlet B2 of the vortex mineralization pipeline may be connected with a third inlet C1 of the intermediate ore treatment pipeline.

The static separator is a device for separation flotation of mineral particles of different physical properties. The separation chamber 20 is a space in the static separator where minerals are subjected to separation flotation. The vortex mineralizer is a device for mineralizing the mineral particles. The mineralization cylinder 30 is a space in the vortex mineralizer where the minerals are mineralized. In some embodiments, the separation chamber 20 and the mineralization cylinder 30 may be of various shapes, such as a regular space or an irregular space. For example, as shown in FIG. 1, the separation chamber 20 and the mineralization cylinder 30 are both cylindrical spaces.

In some embodiments, as shown in FIG. 1, the separation chamber 20 may be provided with the raw ore treatment pipeline from top to bottom and the intermediate ore treatment pipeline from bottom to top which are integrated. That is, the raw ore treatment pipeline and the intermediate ore treatment pipeline may overlap in path in the separation chamber 20.

The raw ore treatment pipeline is a pipeline for treating a raw ore slurry. The raw ore treatment pipeline may include a first inlet A1 and the first outlet A2. The first inlet A1 may be disposed above the first outlet A2. The vortex mineralization pipeline is a pipeline for mineralizing the slurry. The vortex mineralization pipeline may include the second inlet B1 and the second outlet B2.

The intermediate ore treatment pipeline is a pipeline for treating an aerated intermediate ore slurry. The intermediate ore treatment pipeline may include the third inlet C1.

In some embodiments, the raw ore slurry may enter the separation chamber 20 from the first inlet A1 of the raw ore treatment pipeline and move downward along the raw ore treatment pipeline. After filling the separation chamber 20, the raw ore slurry may be discharged from the first outlet A2 of the raw ore treatment pipeline, and transported to the second inlet B1 of the vortex mineralization pipeline by a circulation pump 10 to enter the mineralization cylinder 30 for mineralization to obtain the aerated intermediate ore slurry. The aerated intermediate ore slurry may be discharged from the second outlet B2 of the vortex mineralization pipeline to the third inlet C1 of the intermediate ore treatment pipeline, and enter the separation chamber 20 for separation flotation. During the separation flotation process, the raw ore slurry may continuously enter the separation chamber 20 from the first inlet A1 of the raw ore treatment pipeline to collide with tiny bubbles in the aerated intermediate ore slurry and mineralize. After multiple times of circulation mineralization, concentrate particles may adhere to the bubbles and float upward with the bubbles to form stable concentrate froth at a top of the separation chamber 20, and finally concentrate collection may be achieved at the top of the separation chamber 20. Flotation tailings may be discharged from a tailings discharge pipe 22 set disposed at a bottom of the separation chamber 20. More descriptions regarding the tailings discharge pipe 22 may be found in the present disclosure below.

In some embodiments, as shown in FIG. 1, the circulation pump 10 may be disposed between the first outlet A2 of the raw ore treatment pipeline and the second inlet B1 of the vortex mineralization pipeline.

The circulation pump 10 is a device for transporting the slurry. For example, the circulation pump 10 is a centrifugal circulation pump, a sine pump, or the like. The first outlet A2 of the raw ore treatment pipeline may be connected with the second inlet B1 of the vortex mineralization pipeline through the circulation pump 10, and the second outlet B2 of the vortex mineralization pipeline may be connected with the third inlet C1 of the intermediate ore treatment pipeline, such that the intermediate ore slurry may be circulated in the static separator and the vortex mineralizer.

In some embodiments, as shown in FIG. 1, the second inlet B1 of the vortex mineralization pipeline may be connected with one or more air conduits 31. The one or more air conduits 31 are conduits for delivering air into the mineralization cylinder 30. The one or more air conduits 31 may be configured to inject air into the raw ore slurry or the intermediate ore slurry in the mineralization cylinder 30 for mineralization of the minerals. The air injected by the one or more air conduits 31 may be sufficiently dispersed after treatment in the vortex mineralization pipeline to form the tiny bubbles in the slurry to collide with the mineral particles and mineralize to form the aerated intermediate ore slurry.

In some embodiments, each of the one or more air conduits 31 may further include an air distribution pipe 311. The air distribution pipe 311 is a pipe used for air distribution. A count of the one or more air conduits 31 may match a count of the air distribution pipes 311. The air distribution pipes 311 may be connected to an external air pump to obtain the air and distribute the air equally to each air conduit 31 connected with each air distribution pipe 311. The air pump is a device that provides a power source for injecting air into the one or more air conduits 31. For example, the air pump is a piston pump, a gear pump, a screw pump, or other air pump, etc.

In some embodiments, a one-way valve may be mounted on each of the one or more air conduits 31 in a direction of air movement to avoid the slurry from entering the one or more air conduits 31 and the air distribution pipes 311.

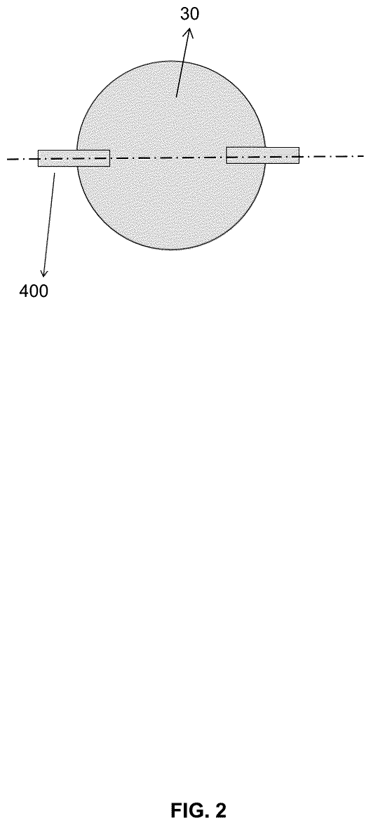

FIG. 2 is a schematic structural diagram illustrating an exemplary inlet pipeline according to some embodiments of the present disclosure.

In some embodiments, as shown in FIG. 1, the second inlet B1 of a vortex mineralization pipeline may be provided on a bottom side wall of the mineralization cylinder 30. The first outlet A2 of a raw ore treatment pipeline may be connected with the second inlet B1 through one or more inlet pipelines. The vortex mineralization pipeline may include at least two inlet pipelines 400 disposed opposite to each other.

The inlet pipeline 400 is a pipeline through which the slurry enters the mineralization cylinder 30. In some embodiments, as shown in FIG. 2, the vortex mineralization pipeline may include two inlet pipelines 400 disposed opposite to each other. In some embodiments, the vortex mineralization pipeline may include four inlet pipelines disposed opposite to each other. In some embodiments, three inlet pipelines five inlet pipelines, or more inlet pipelines, etc., may be provided as appropriate. For example, as shown in FIG. 1 and FIG. 2, the two inlet pipelines 400 are disposed opposite to each other and face a central axis of the mineralization cylinder 30, to enable the slurry to enter the mineralization cylinder 30 in the form of an impinging stream. The impinging stream may enhance turbulence dissipation, induce small-scale vortexes, and strengthen the collision and adhesion of microfine minerals to bubbles. In addition, the impinging stream may avoid affecting the operation effect caused by accumulation of the intermediate ore slurry at the bottom of the vortex mineralizer.

In some embodiments, the second inlet B1 of the vortex mineralization pipeline may be pressurized to increase strength of the impinging stream.

In some embodiments, as shown in FIG. 1, each of the one or more inlet pipelines may include a slurry distribution tank 40 and a slurry distribution pipe 41. The slurry distribution tank 40 may be provided around a top side wall of the mineralization cylinder 30. The slurry distribution tank 40 may be connected with the slurry distribution pipe 41 provided vertically. A count of the slurry distribution pipes 41 may match a count of the one or more inlet pipelines.

The slurry distribution tank 40 is a device used for distributing the intermediate ore slurry. The slurry distribution pipe 41 is a device for transporting the intermediate ore slurry distributed by the slurry distribution tank 40 to the mineralization cylinder 30. The slurry distribution tank 40 may be configured to connect at least two slurry distribution pipes 41. In some embodiments, the intermediate ore slurry may be discharged from the separation chamber 20 through the first outlet A2 and enter the slurry distribution tank 40, and a distributed intermediate ore slurry may be transported to the second inlet B1 of the vortex mineralization pipeline through the slurry distribution pipes 41 to strengthen the collision of the intermediate ore slurry.

The slurry distribution tank 40 and the slurry distribution pipe 41 may be connected by a conventional connection mode. For example, the conventional connection mode may include connecting by a connection flange, threads, or the like. The slurry distribution pipe 41 may be connected with the original inlet pipeline of the intermediate ore treatment pipeline or in place of the original inlet pipeline, and the inlet pipeline may also extend for a certain distance to the inside of the mineralization cylinder to strengthen the collision.

In some embodiments, a lining jet pipe 41 (not shown in the drawings) may be provided at a connection end between the slurry distribution pipe 41 and the slurry distribution tank 40. The one or more air conduits 31 may be connected with a side of the slurry distribution pipe 41 close to the lining jet pipe. The slurry distribution tank 40 may distribute the intermediate ore slurry into the slurry distribution pipe 41 through the lining jet pipe. The lining jet pipe may regulate the speed and pressure of the intermediate ore slurry, and enable the air from the one or more air conduits 31 to break into bubbles to be mixed with the slurry to form an aerated intermediate ore slurry. The aerated intermediate ore slurry may enter the mineralization cylinder 30 through the second inlet B1.

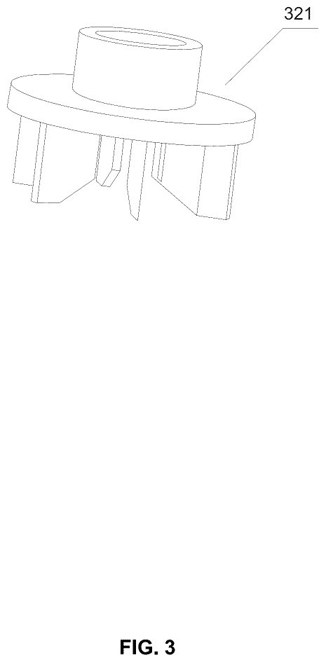

FIG. 3 is a schematic structural diagram illustrating an exemplary mineralization impeller according to some embodiments of the present disclosure.

In some embodiments, as shown in FIG. 1 and FIG. 3, an agitation device 32 may be disposed in the mineralization cylinder 30. The agitation device 32 may include a mineralization impeller 321 configured to generate a vortex. The mineralization impeller 321 may be disposed above the second inlet B1.

The agitation device 32 is a device that stirs an intermediate ore slurry and bubbles in the mineralization cylinder 30 to achieve mineralization. The agitation device 32 may be a mechanical agitator, or the like.

The mineralization impeller 321 may be set to different shapes. For example, as shown in FIG. 3, the mineralization impeller 321 may be a half-open impeller. A top of the mineralization impeller 321 may be closed by a cover plate, and a bottom of the mineralization impeller 32 may be in an open state, such that the intermediate ore slurry from below the mineralization impeller 321 is stirred while avoid influencing a flow field above the mineralization impeller 321. For example, as shown in FIG. 3, the mineralization impeller 321 may be a half-open radial impeller, i.e., blades of the impeller may be set vertically, such that the fluid moves in a horizontal plane after the fluid is stirred. The agitation device 32 may enhance the formation of tiny bubbles from the air entering the intermediate ore slurry by stirring of the mineralization impeller 321, and induce small-scale vortexes to strengthen the mineralization of intermediate ore particles with the bubbles.

For example, as shown in FIG. 1, the agitation device 32 is a rod having a stirring shaft. The stirring shaft may be provided along an axis of the mineralization cylinder 30. The mineralization impeller 321 may be disposed at one end of the stirring shaft. The stirring shaft may rotate to drive the mineralization impeller 321 to operate.

In some embodiments, the top of the mineralization cylinder 30 may be sealed by a sealing cover plate 35, and an ore discharge pipe 36 may be disposed at a bottom of the mineralization cylinder 30. The vortex mineralizer may be connected with a power device. The power device may be disposed on the sealing cover plate 35. The power device may be electrically connected with an agitation device 32.

The sealing cover plate 35 is a device for sealing a top outlet of the mineralization cylinder 30 to prevent the slurry from overflowing from the top of the mineralization cylinder 30.

The ore discharge pipe 36 is a pipe for discharging a residual slurry. The ore discharge pipe 36 may be closed during mineralization of the slurry and separation flotation. When the separation flotation is completed, the ore discharge pipe 36 may be opened to discharge the residual slurry in the separation chamber 20 and the mineralization cylinder 30.

The power device is a device that provides a power source for the agitation device 32 to mix the slurry. For example, the power device is different types of motors, hydraulic presses, or the like. For example, as shown in FIG. 1, the power device may be a drive motor 37, and the drive motor 37 may be disposed on the sealing cover plate 35 at the top of the mineralization cylinder 30. One end of the stirring shaft of the agitation device 32 may be connected with the mineralization impeller 321, and the other end of the stirring shaft of the agitation device 32 may be connected with the drive motor 37. The drive motor 37 may drive the stirring shaft to rotate to drive the mineralization impeller 321 to operate.

In some embodiments, as shown in FIG. 1, the first inlet A1 of the raw ore treatment pipeline may be disposed above the separation chamber 20. The first inlet A1 may be connected with a feed pipe 21. A discharge end of the feed pipe 21 may extend towards the inside of the separation chamber 20 and bend towards a bottom of the separation chamber 20. A mouth of the discharge end of the feed pipe 21 may be closed, and a pipe wall of the discharge end may be provided with one or more through holes.

The feed pipe 21 is an entry pipe for the raw ore slurry. An inlet end of the feed pipe 21 may be the first inlet A1. The mouth of the discharge end of the feed pipe 21 may be closed, and the side pipe wall of the discharge end of the feed pipe 21 may be provided with a plurality of through holes for the raw ore slurry to flow out, such that the raw ore slurry uniformly enters the separation chamber 20.

In some embodiments, as shown in FIG. 1, the third inlet C1 of the intermediate ore treatment pipeline may be disposed on a bottom side wall of the separation chamber 20. A cyclone cone 23 may be disposed in the separation chamber 20. A side wall of the cyclone cone 23 may be a slope surface, and the third inlet C1 may be disposed opposite to the slope surface. The third inlet C1 may be provided with one or more cyclone pipes 231. The one or more cyclone pipes 231 may be disposed at a preset deflection angle towards the cyclone cone 23.

The cyclone cone 23 is a conical member for forming a cyclone inside the separation chamber 20. The cyclone cone may be a conical cylinder, a diameter of the conical cylinder increasing gradually from top to bottom. The intermediate ore slurry may enter the separation chamber 20 from the third inlet C1 of the intermediate ore treatment pipeline and impact the slope surface of the cyclone cone 23 to form the cyclone.

The cyclone pipe 231 is a tubing at the end of the third inlet C1 for forming a cyclone. The preset deflection angle refers to a preset angle between the one or more cyclone pipes 231 and the side wall surface of the separation chamber 20. The preset deflection angle may be set based on experience or actual situations.

The intermediate ore treatment pipeline may include at least two third inlets C1 arranged opposite each other, and a count of the cyclone pipes 231 may match a count of the third inlets C1. The at least two cyclone pipes 231 may be disposed at the same preset deflection angle, such that the slurry impacting the cyclone cone 23 can greatly strengthen the cyclone. The intermediate ore slurry may form a cyclone centrifugal force field in a region where the cyclone cone 23 is located, which can strengthen the collision and adhesion between mineral particles and bubbles. Meanwhile, under the action of the cyclone centrifugal force field, low-density mineralized bubbles may move towards a central region of the static separator, which facilitates the separation of the mineralized bubbles from unmineralized particles, and strengthens the separation process.

In some embodiments, as shown in FIG. 1, the intermediate ore treatment pipeline may include an intermediate ore recirculation feed chute 50 and at least one intermediate ore distribution pipe 51 disposed around the separation chamber 20. The intermediate ore recirculation feed chute 50 may be disposed close to a bottom of the first inlet A1 of the raw ore treatment pipeline. The intermediate ore recirculation feed chute 50 may be connected with the third inlet C1 through the at least one intermediate ore distribution pipe 51. An outlet of each of the at least one intermediate ore distribution pipe 51 may be connected with the cyclone pipe 231. The one or more cyclone pipes 231 may be disposed at the same deflection angle towards the cyclone cone 23.

The intermediate ore recirculation feed chute 50 is a device for distributing an aerated intermediate ore slurry. The at least one intermediate ore distribution pipe 51 is a device for transporting the aerated intermediate ore slurry distributed by the intermediate ore recirculation feed chute 50 to the separation chamber 20. The intermediate ore recirculation feed chute 50 may be connected with the at least one intermediate ore distribution pipe 51.

The aerated intermediate ore slurry may be transported to the third inlet C1 of the intermediate ore treatment pipeline through the at least one intermediate ore distribution pipe 51 to form a starting point of the intermediate ore treatment pipeline, so as to strengthen the cyclone in conjunction with the cyclone cone 23.

The intermediate ore recirculation feed chute 50 may be connected with the at least one intermediate ore distribution pipe 51 by a conventional connection mode. The conventional connection mode may include connecting by a connecting flange, threads, or the like. The slurry distribution pipe 41 and the at least one intermediate ore distribution pipe 51 may be connected with the original inlet pipeline of the intermediate ore treatment pipeline or in place of the original inlet pipeline, and the inlet pipeline may also extend for a certain distance to the inside of the separation chamber 20 to strengthen the cyclone.

In some embodiments, the third inlet C1 of the intermediate ore treatment pipeline may be pressurized to increase the strength of the cyclone.

In some embodiments, as shown in FIG. 1, the cyclone cone 23 may be a conical cylinder through a vertical direction, an inner diameter of the bottom of the cyclone cone 23 may match an inner diameter of the separation chamber 20, which ensures that the ore slurry flows in the separation chamber 20, and allows the intermediate ore slurry to enter the first outlet A2 of the raw ore treatment pipeline through the conical cylinder after separation flotation.

In some embodiments, the vortex mineralization-static separation flotation device may further include the tailings discharge pipe 22. The tailings discharge pipe 22 and the first outlet A2 of the raw ore treatment pipeline may be disposed below the bottom of the cyclone cone 23, such that tailings enter the tailings discharge pipe 22 through the cyclone cone 23 after the separation flotation. The tailings discharge pipe 22 is a pipe for discharging the tailings. The tailings discharge pipe 22 may be provided on the bottom side wall of the separation chamber 20.

In some embodiments, the bottom of the separation chamber may be a slope inclined towards the tailings discharge pipe 22, so as to facilitate the tailings to discharge.

In some embodiments, an intermediate ore inverted cone 25 may be disposed at the bottom of the separation chamber. The intermediate ore inverted cone 25 is a cone with an opening towards a bottom of the conical cylinder. The first outlet A2 of the raw ore treatment pipeline may be disposed on a side wall of the intermediate ore inverted cone 25. The intermediate ore inverted cone 25 is a conical structural member for discharging the tailings and the intermediate ore slurry. Under the effect of the cyclone centrifugal force field, low-density intermediate ore particles may move towards the central region of the static separator and sink into the intermediate ore inverted cone 25, and may be transported to the vortex mineralizer for forced recovery through the first outlet A2 of the raw ore treatment pipeline. High-density tailings particles may move towards a wall of the static separator and may be collected by the tailings discharge pipe 22 to form the tailings, thereby realizing reasonable separation of the intermediate ore and the tailings.

In some embodiments, an inclined plate 221 may be disposed at the bottom of the separation chamber, and a base of the intermediate ore inverted cone 25 may penetrate through the inclined plate 221 or form a stable connection with the inclined plate 221. An upper surface of the inclined plate 221 may be a slope that inclines towards the tailings discharge pipe 22.

In some embodiments, a stop cover 251 may be disposed at the opening of the intermediate ore inverted cone 25. The stop cover 251 may be in clearance connection with an upper edge of the intermediate ore inverted cone 25, such that the intermediate ore particles enter the interior of the intermediate ore inverted cone 25.

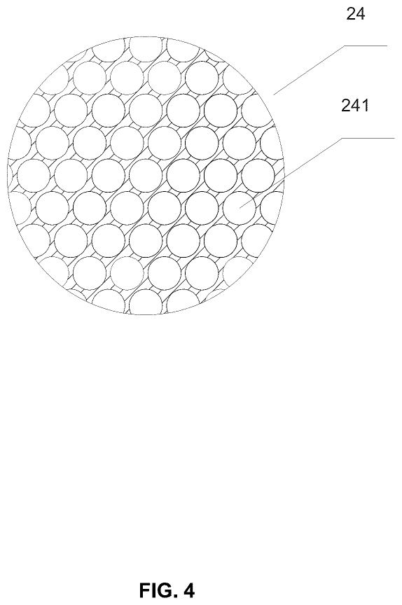

FIG. 4 is a schematic structural diagram illustrating an exemplary sieve plate according to some embodiments of the present disclosure.

In some embodiments, as shown in FIG. 1 and FIG. 4, one or more horizontally arranged sieve plates 24 may be disposed in the separation chamber 20. A size of each of the one or more sieve plates 24 may match an inner diameter of the separation chamber 20. Penetration circular holes 241 may be uniformly disposed in the one or more sieve plates 24. The one or more sieve plates 24 are structural members for separating the separation chamber 20. The penetration circular holes disposed in the one or more sieve plates 24 may be used for slurry flow. A size of each of the penetration circular holes 241 may be set according to experience or actual situations. For example, the larger the mineral particles in the slurry, the larger the penetration circular holes 241.

In some embodiments, the one or more sieve plates 24 may separate the separation chamber 20 into interconnected partitions. A plurality of sieve plates 24 may be provided. In some embodiments, the one or more sieve plates 24 may include at least a first sieve plate 24a, a second sieve plate 24b, and a third sieve plate 24c. The first sieve plate 24a may be disposed above the first inlet A1 of a raw ore treatment pipeline. The second sieve plate 24b may be disposed below the first inlet A1. The third sieve plate 24c may be disposed above the third inlet C1 of an intermediate ore treatment pipeline. A static separation region of the separation chamber 20 may be formed between the second sieve plate 24b and the third sieve plate 24c.

The penetration circular holes 241 may be uniformly disposed the first sieve plate 24a, the second sieve plate 24b, and the third sieve plate 24c. The static separation region is a main region of the separation chamber 20 for separation flotation of an aerated intermediate ore slurry. The static separation region may include a countercurrent mineralization region. The countercurrent mineralization region is a region where a raw ore slurry collides with a countercurrent aerated intermediate ore slurry to mineralize. In the static separation region, mineral particles in the raw ore treatment pipeline may perform countercurrent collision with tiny bubbles in the intermediate ore treatment pipeline for mineralization. A cyclone mineralization region may be formed between the third sieve plate 24c and the cyclone cone 23. The aerated intermediate ore slurry entering from the third inlet C1 may undergo cyclone mineralization movement in the cyclone mineralization region. The third sieve plate 24c may reduce the influence of the cyclone movement of the ore slurry in the cyclone mineralization region of the separation chamber 20 on a flow field of the countercurrent mineralization region, so as to create a relatively static countercurrent mineralization region of the raw ore treatment pipeline. A suitable flow field environment may be provided for countercurrent mineralization of the coarser particles and the bubbles, and smooth floating and separation of mineralized bubbles may be facilitated.

In some embodiments, two horizontally oriented circular plates 33 may be disposed in the vortex mineralizer. Edges of the two circular plates 33 may be closely connected with an inner wall of the mineralization cylinder 30. The two circular plates 33 are annular structural members used for separate a space of the mineralization cylinder 30 to form different regions. A center hole 331 may be disposed in a central region of each of the two circular plates 33. The center hole 331 may be used for slurry flow.

In some embodiments, the two circular plates may include a first circular plate 33a and a second circular plate 33b. The first circular plate 33a may be disposed between the second inlet B1 of the vortex mineralization pipeline and the mineralization impeller 321 to form an impinging stream mineralization chamber for an intermediate ore slurry with a bottom of the mineralization cylinder 30. The second circular plate 33b may be disposed below the second outlet B2 of the vortex mineralization pipeline to form a discharge chamber for the intermediate ore slurry with a top of the mineralization cylinder 30. The center hole 331 may be disposed in the central region of the first circular plate 33a and the second circular plate 33b, respectively, for slurry flow.

The intermediate ore slurry may achieve impinging stream collision and mineralization in the impinging stream mineralization chamber, and may be discharged from the mineralization cylinder 30 through a discharge chamber. In the impinging stream mineralization chamber, the second inlet B1 of the vortex mineralization pipeline may be provided with one or more inlet pipelines to make the intermediate ore slurry enter the mineralization cylinder 30 in the form of impinging stream. The impinging stream may enhance turbulence dissipation, induce small-scale vortexes, and strengthen the collision and adhesion of the microfine minerals to the bubbles. In addition, the impinging stream may avoid affecting the operation effect caused by accumulation of the intermediate ore slurry at the bottom of the vortex mineralizer.

In some embodiments, a vortex mineralization region may be formed between the first circular plate 33a and the second circular plate 33b. The vortex mineralization region is a region where the slurry is mineralized by vortexes generated by the agitation device 32.

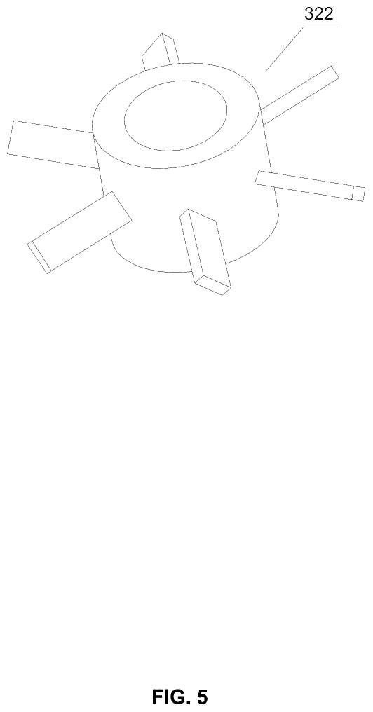

FIG. 5 is a schematic structural diagram illustrating an exemplary dispersion circulation impeller according to some embodiments of the present disclosure.

In some embodiments, as shown in FIG. 1 and FIG. 5, the agitation device 32 may further include a dispersion circulation impeller 322. The dispersion circulation impeller 322 may be disposed below a second circular plate. The dispersion circulation impeller 322 is a device configured to stir a slurry and achieve dispersion and circulation of the pulp. In some embodiments, the dispersion circulation impeller 322 may be an open impeller with no coverage around the impeller, so as to achieve full agitation of the slurry around the dispersion circulation impeller 322. As shown in FIG. 5, the dispersion circulation impeller 322 may be an axial downward pressure flow impeller, i.e., blades may be set inclinedly to provide axial kinetic energy to a stirred fluid.

In some embodiments, a central circular plate 33c may be disposed between the dispersion circulation impeller 322 and the mineralization impeller 321. A dispersion circulation mineralization chamber may be formed between the central circular plate 33c and the second circular plate 33b. A vortex forced mineralization chamber may be formed between the central circular plate 33c and the first circular plate 33a. The central circular plate 33c is an annular structural member disposed in a central portion of the mineralization cylinder 30 and partitioning the central portion of the mineralization cylinder 30. A central region of the central circular plate 33c may be provided with the center hole 331 for slurry flow.

The mineralization impeller 321 may be disposed in the vortex forced mineralization chamber. The mineralization impeller 321 may be a half-open radial impeller. High-speed rotation of the mineralization impeller 321 is capable of generating strong turbulence to induce small-scale turbulence micro vortexes, which strengthens the dispersion of bubbles and generates micro-bubbles, and is also conducive to force microfine mineral particles to break fluid streamlines and strengthen the mineralization between the microfine mineral particles and the bubbles. The dispersion circulation impeller 322 may be disposed in the dispersion circulation mineralization chamber. The dispersion circulation impeller 322 may be an open axial downward pressure flow impeller. High-speed rotation of the dispersion circulation impeller 322 may generate an axial downward pressure flow, which can promote the downward circulation movement of the slurry, increase the residence time of the mineral particles in the cylinder, and improve the frequency of the collision of the mineral particles with the bubbles.

Because a top of the mineralization cylinder 30 forms a closed and restricted space, a high-pressure solution environment is easily formed inside the vortex mineralizer during the operation process, which strengthens the concentration of energy and enhances the turbulence movement. Meanwhile, in the high-pressure solution environment, the solubility of air is enhanced, which is conducive to generating micro and nano bubbles, strengthening air dispersion and interfacial nano bubble bridging, and providing suitable bubble carriers and interfacial mineralization conditions for the mineralization of the microfine minerals for flotation.

In some embodiments, a diameter of the center hole 331 of the first circular plate 33a may be less than or equal to a blade diameter of the mineralization impeller 321, and diameters of the center holes 331 of the central circular plate 33c and the second circular plate 33b may both be greater than the blade diameter of the mineralization impeller and a blade diameter of the dispersion circulation impeller. Thus, the first circular plate 33a, the second circular plate 33b, and the central circular plate 33c can sufficiently reduce the influence of flow fields between different regions.

The internal space of the mineralization cylinder 30 may be partitioned through the first circular plate 33a and the second circular plate 33b, such that the intermediate ore slurry and the bubbles may be subjected to impinging stream mineralization, vortex mineralization, and slurry circulation in sequence in a direction of the vortex mineralization pipeline in the entire device to be adapted to different stages of mineralization of the mineral particles and the bubbles, thereby achieving efficient mineralization recovery of the mineral particles through reasonable adaptation of the turbulence energy.

In some embodiments, as shown in FIG. 1, a plurality of circumferentially distributed baffles 341 may be disposed on a top surface of the first circular plate 33a and a bottom surface of the second circular plate 33b. A long side of each of the plurality of baffles 341 may abut against an inner wall of the mineralization cylinder 30. A width of each of the plurality of baffles 341 may be less than a circular ring width of each of the first circular plate 33a and the second circular plate 33b. The plurality of baffles 341 are structural members for supporting the first circular plate 33a and the second circular plate 33b. For example, the plurality of baffles may be arranged radially around circumferential sides of the center holes 331 of the circular plates 33.

One or more circumferentially arranged liner plates 342 may be disposed on a bottom surface and a top surface of the central circular plate 33c. A long side of each of the one or more liner plates 342 may abut against the inner wall of the mineralization cylinder 30, and a width of each of the one or more liner plates 342 may be less than the circular ring width of the central circular plate. The one or more liner plates 342 are structural members for supporting the central circular plate 33c. For example, the one or more liner plates 342 may be arranged radially around a circumferential side of the center hole 331 of the central circular plate 33c.

The plurality of baffles 341 and the one or more liner plates 342 are capable of supporting the circular plates 33, and also preventing the slurry from forming a cyclone flow that adheres to the inner wall of the mineralization cylinder 30, thereby improving the mineralizing effect.

In some embodiments, the plurality of baffles 341 disposed on the top surface of the first circular plate 33a may extend upwardly to a position beyond a top surface of the mineralization impeller 321, and the plurality of baffles 341 disposed on the bottom surface of the second circular plate 33b may extend downwardly to a position beyond a bottom surface of the dispersion circulation impeller 322, thereby further avoiding cyclone formation.

It should be noted that the count, shape, etc., of the plurality of baffle plates 341 and the one or more liner plates 342 are not specifically required, as long as satisfying the use requirements.

In some embodiments, as shown in FIG. 1, the vortex mineralization-static separation flotation device may include a concentrate collection device 60. The concentrate collection device 60 may be disposed above a top of the separation chamber 20, and an overflow opening may be disposed at the top of the separation chamber 20. For example, the top of the separation chamber 20 may be provided with an open mouth, and the open mouth may serve as the overflow opening. The concentrate collection device 60 may include a collection tank body 61. An inner diameter of the collection tank body 61 may be greater than an outer diameter of the separation chamber 20. A bottom of the collection tank body 61 may be provided with a groove matching a size of the overflow opening. The concentrate collection device 60 may be sleeved and fixed on a top outer side of the separation chamber 20.

The concentrate collection device 60 is a device for collecting a target concentrate. The target concentrate is a fine mineral required by a user. The overflow opening is an opening for overflowing of concentrate froth. In some embodiments, the inner diameter of the collection tank body 61 may be greater than an outer diameter of the overflow opening.

In some embodiments, a bottom plate 62 of the collection tank body 61 may be provided with a concentrate discharge opening 621. The bottom plate 62 may be inclined towards a direction of the concentrate discharge opening 621. The concentrate discharge opening 621 is an outlet for the concentrate collection device 60 to discharge the collected target concentrate. The concentrate collection device 60 may be configured to collect the concentrate froth overflowed from the overflow opening of the separation chamber 20 through the collection tank body 61, and the overflowed concentrate froth may flow into the collection tank body 61 to flow towards the concentrate discharge opening 621 along the inclined bottom plate 62 to obtain the target concentrate.

In some embodiments, as shown in FIG. 1, the concentrate collection device 60 may further include a flushing system 70. The flushing system 70 may include a flushing water ring 71 and a water inlet pipe 72 connected with the flushing water ring 71. The flushing water ring 71 may be provided in a circle along a columnar inner side wall of the concentrate collection device 60. At least one flushing water outlet may be disposed on the flushing water ring 71. The at least one flushing water outlet may face the bottom plate 621.

The flushing system 70 is a system for flushing the concentrate froth. The flushing water ring 71 is a water outlet distribution device of the flushing system 70. The flushing water ring 71 may be provided with a water valve, and a flushing water flow rate of the flushing water outlet may be adjusted by the water valve. The flushing system 70 may flush and promote the discharge of the concentrate froth from the bottom plate 621 through the flushing water ring 71 and the at least one flushing water outlet of the flushing water ring 71.

In some embodiments, a flow meter may be provided at the second inlet B1 and/or the second outlet B2 of the vortex mineralization pipeline. The flow meter may be configured to monitor a slurry flow rate.

In some embodiments, a first solenoid valve may be provided at the first inlet A1 of the raw ore treatment pipeline. The first solenoid valve may be configured to regulate a raw ore feed rate.

In some embodiments, a first pressure sensor may be provided at a bottom of the static separator. The first pressure sensor may be configured to monitor tailings accumulation.

In some embodiments, a second pressure sensor may be provided at the concentrate discharge opening 621. The second pressure sensor may be configured to monitor a discharge pressure.

In some embodiments, a second solenoid valve may be provided at the ore discharge pipe 36. The second solenoid valve may be configured to control a discharge rate of the residual slurry. On/off of the second solenoid valve may be remotely controlled. For example, on/off of the second solenoid valve may be controlled by a processor.

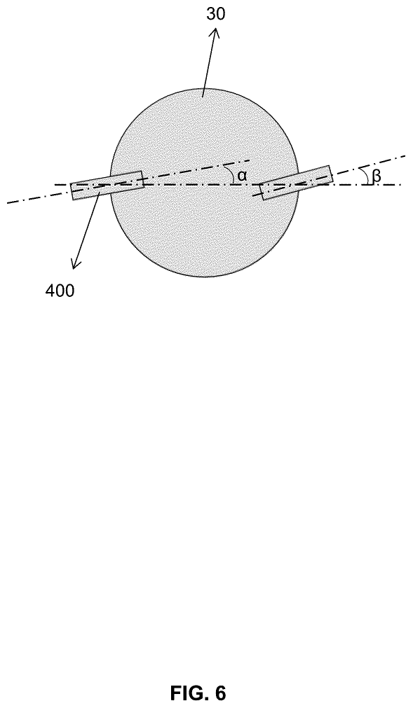

FIG. 6 is a schematic structural diagram illustrating another exemplary inlet pipeline according to some embodiments of the present disclosure.

In some embodiments, two inlet pipelines 400 may be inclinedly arranged with respect to the mineralization cylinder 30. In some embodiments, inclination angles formed between the two inlet pipelines 400 and the mineralization cylinder 30 are adjustable.

The inclination angle is an angle between a central axis of the inlet pipeline and a central axis of the mineralization cylinder 30 in a horizontal direction. The inclination angles of the two inlet pipelines 400 may be the same or different. For example, as shown in FIG. 6, the inclination angles of the two inlet pipelines 400 may be denoted as a and B, respectively, a and B being the same or different.

An exemplary structure in which the inclination angles formed between the two inlet pipelines 400 and the mineralization cylinder 30 are adjustable may include that: each of the two inlet pipelines is divided into 3 segments, two ends of each inlet pipeline being straight pipes, a middle portion of each inlet pipeline being a corrugated pipe, and deformation degrees of two sides of the corrugated pipe being different to form different inclination angles. The deformation degrees of the two sides of the corrugated pipe may be controlled by a cylinder.

By inclinedly arranging the inlet pipelines, vortexes can be created at the bottom of the mineralization cylinder, which slows down the accumulation of the tailings.

Some embodiments of the present disclosure include, but are not limited to, the following beneficial effects.

(1) Flotation separation of minerals of different grain sizes is achieved by connecting the static separator and the vortex mineralizer separately arranged. After the static separator and the vortex mineralizer are filled with the raw ore slurry under flotation, the raw ore slurry moves the countercurrent downward movement along the raw ore treatment pipeline to penetrate through the static countercurrent mineralization region formed by the plurality of sieve plates. The coarse particles easy to float perform countercurrent mineralization with the bubbles to form mineralized bubbles for recovery by flotation. The unmineralized particles continue to move downward with the fluid to pass through the cyclone mineralization region of the cyclone cone. The slurry turbulence strength and dissipation increase, strengthening collision and adhesion of the medium-sized particles and the bubbles. After passing through the cyclone mineralization zone, the microfine particles that are still unmineralized continue to move downward, and are transported to the vortex mineralizer through the intermediate ore discharge pipe. The strong turbulence is formed inside the vortex mineralizer under the collision of the fluid and strong mixing of the impeller, and the turbulence dissipation is further enhanced, which induces the generation of small-scale turbulence vortexes, forcing the microfine mineral particles to break through the limitation of the fluid stream lines to collide with and adhere to the bubbles to realize the mineralization of the microfine mineral particles. In the present disclosure, the mineral particles and the bubbles are subjected to countercurrent mineralization, cyclone mineralization, and vortex mineralization in sequence in the static separator and the vortex mineralizer along the flow direction, and accordingly the turbulence dissipation gradient enhances, and the turbulence vortex scale gradient reduces, so as to adapt to mineralization flotation of the mineral particles of different particle size, and realize the efficient flotation recovery of the mineral particles of various particle sizes through the gradient adaptation of turbulence energy.

(2) The cyclone cone is disposed in the separation chamber, making the circulation intermediate ore form the cyclone centrifugal force field in the region of the cyclone cone, and constructing the cyclone mineralization region of which the turbulence strength is between the weak turbulence countercurrent mineralization region and the strong turbulence vortex mineralization region to strengthen the collision and adhesion of the medium-sized particles and the bubbles. In addition, under the action of the cyclone centrifugal force field, the low-density mineralized bubbles move to the central region of the static separator, which helps to separate the mineralized bubbles from the unmineralized particles, and enhances the separation process. Furthermore, under the action of the cyclone centrifugal force field, the relatively low-density intermediate ore particles move towards the central region of the static separator below the cyclone cone, and sink to the intermediate ore inverted cone to be transported to the vortex mineralizer, while the relatively high-density tailings particles move towards the wall of the static separator to be collected by the tailings discharge pipe to form the tailings, thereby realizing the reasonable separation of the intermediate ore and the tailings.

(3) The plurality of sieve plates are disposed in the static separator, which effectively isolate the influence of the slurry feeding in the static separator and the cyclone movement of the slurry in the cyclone region on the flow field of the countercurrent mineralization region, and create a relatively static countercurrent mineralization region, thereby providing a suitable flow field environment for the countercurrent mineralization of the coarse particles and the bubbles and facilitating the smooth flotation and separation of the mineralized bubbles.

(4) The mineralization cylinder is divided into four chambers by providing three circular plates, which are the impinging stream mineralization chamber, the vortex forced mineralization chamber, the dispersion circulation mineralization chamber, and the discharge chamber from bottom to top. The vortex forced mineralization chamber generates the strong turbulence through the high-speed rotation and stirring of the mineralization impeller, inducing the small-scale turbulence micro-vortexes, which strengthens the dispersion of the bubbles and generates micro-bubbles, and forces the microfine mineral particles to break through the limitation of the fluid stream lines to strengthen the mineralization with the bubbles. The dispersion circulation mineralization chamber generates the axial downward pressure flow through the stirring of the dispersion circulation impeller disposed in the chamber to promote the slurry to perform the downward circulation movement, thereby increasing the residence time of the mineral particles in the cylinder, and improving the frequency of the collision with the bubbles.

(5) In the vortex forced mineralization chamber, the impinging stream is produced at the bottom of the vortex mineralizer by the inlet pipelines, which enhances the turbulence dissipation, induces the small-scale vortexes, and strengthens the collision and adhesion of the microfine mineral particles and the bubbles. In addition, the operation effect is prevented from being affected by the accumulation of the intermediate ore slurry at the bottom of the vortex mineralizer.

(6) The top of the vortex mineralizer forms the closed and restricted space, and during the operation process, the high-pressure solution environment is formed inside the vortex mineralizer, which further strengthens the concentration of energy and enhances the turbulence. In addition, in the high-pressure solution environment, the solubility of air is enhanced, which is conducive to generating the micro and nano bubbles, strengthening air dispersion and interfacial nano bubble bridging, and providing suitable bubble carriers and interfacial mineralization conditions for the mineralization of the microfine minerals for flotation.

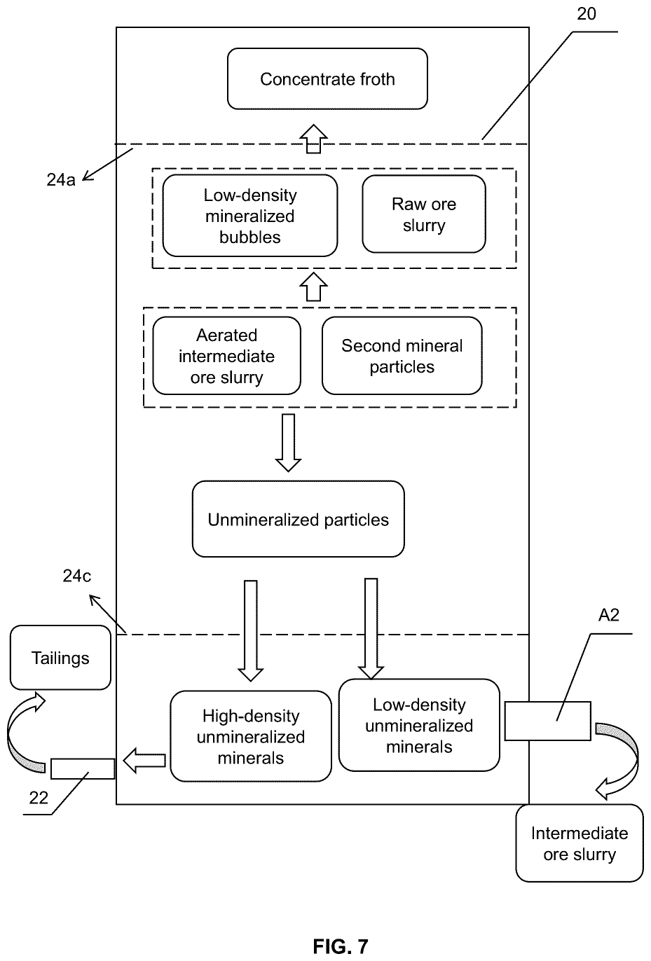

FIG. 7 is a schematic diagram illustrating an exemplary process of separation flotation according to some embodiments of the present disclosure.

In some embodiments, a vortex mineralization-static separation flotation method may be implemented by a vortex mineralization-static separation flotation device. The vortex mineralization-static separation flotation device may further include a processor. The vortex mineralization-static separation flotation device may implement the vortex mineralization-static separation flotation method through the processor.

In some embodiments, the vortex mineralization-static separation flotation method may include the following operations S1-S5.

S1. the tailings discharge pipe 22 disposed at a bottom of the separation chamber 20 may be closed. A raw ore slurry may enter the separation chamber 20 from the first inlet A1 of a raw ore treatment pipeline and may be discharged through the first outlet A2. The raw ore slurry may enter the mineralization cylinder 30 from the second inlet B1 of a vortex mineralization pipeline. When the mineralization cylinder is full of the raw ore slurry, the raw ore slurry may be discharged from the second outlet B2 of the vortex mineralization pipeline and may enter the separation chamber 20 again from the third inlet C1 of an intermediate ore treatment pipeline.

The raw ore slurry is a slurry consisting of a mixture of minerals that contains the target concentrate and is untreated.

More descriptions regarding the separation chamber, a tailings discharge pipe, the mineralization cylinder, the raw ore treatment pipeline, and the vortex mineralization pipeline may be found in FIGS. 1-6 and related descriptions thereof.

S2. In response to determining that the raw ore slurry in the separation chamber 20 reaches a set level, the one or more air conduits 31, an agitation device, and the tailings discharge pipe 22 may be turned on to make air enter the mineralization cylinder and form tiny bubbles to collide with first mineral particles and mineralize to form an aerated intermediate ore slurry.

The set level is a set value for a level of the raw ore slurry in the separation chamber 20. The set level may be set based on experience or actual situations. The raw ore slurry in the separation chamber 20 reaches the set level, which facilitates the subsequent collision and mineralization of the raw ore slurry and the intermediate ore slurry.

The first mineral particles are mineral particles in the mineralization cylinder 30. The aerated intermediate ore slurry refers to a slurry of mixing the raw ore slurry with air and performing preliminary collision and mineralization. The collision and mineralization may include a particle collision process and a mineralization process. The particle collision refers to the collision of mineral particles in a fluid or gaseous medium as a result of differences in kinetic energy or concentration, resulting in the formation of larger particles or mineral structures through interaction. For example, the particle collision may include mineral particles of different mineral physical properties in the intermediate ore slurry and/or the raw ore slurry colliding with each other. The mineral physical properties include hydrophilicity and density of the mineral particles, or the like. The mineralization process means that the particles after collision may form new minerals through chemical reaction, physical adsorption, or dissolution recrystallization. For example, the mineralization process may include adhesion of hydrophobic mineral particles to surfaces of tiny bubbles, etc.

More descriptions regarding the one or more air conduit 31 and the agitation device 32 may be found in the related descriptions of FIG. 1, FIG. 3, and FIG. 5.

S3. The aerated intermediate ore slurry may enter the separation chamber 20 through the third inlet C1 of the intermediate ore treatment pipeline. The tiny bubbles may be released to collide with second mineral particles in the separation chamber to mineralize. Low-density mineralized bubbles may move towards a center of the separation chamber 20 and float upwardly, unmineralized bubbles may descend, and the low-density mineralized bubbles may perform countercurrent collision with the raw ore slurry entering the separation chamber 20 for mineralization.

The second mineral particles are mineral particles in the separation chamber 20. The low-density mineralized bubbles refer to a mixture of lower-density minerals and the tiny bubbles. Hydrophobic fine minerals in the slurry may adhere to the surface of the bubbles to form the low-density mineralized bubbles. The unmineralized particles are a mixture of mineral particles that are not bound to the tiny bubbles. The unmineralized particles may include mineral particles of multiple physical properties. For example, coarse particles, due to the large mass and kinetic energy, slide fast on the surface of the bubbles and are difficult to adhere to the surface of the bubbles due to the short contact time, prone to desorption by an external force. As another example, microfine particles are easily affected by fluid streamlines during the collision process, and lack sufficient gravity and inertial force to break through the fluid streamlines and collide with the bubbles. As another example, weakly hydrophobic particles, due to the small hydrophobic force, are difficult to break through a liquid membrane between the bubbles and the particles to adhere, and are easily desorbed under the influence of the fluid as the weak adhesion.

In a descending process of the unmineralized particles, the high-density unmineralized particles may rapidly settle to the periphery of the chamber due to the gravity and friction. In addition, the high-density unmineralized particles are more likely to aggregate due to a larger contact area, and tend to form a relatively dense mineral layer at the periphery of the chamber. Therefore, the high-density unmineralized particles may move towards an inner side wall around the separation chamber 20 and descend rapidly. The low-density unmineralized particles may be less affected by gravity and friction, and tend to descend slowly along a middle region of the separation chamber 20.

More descriptions regarding the cyclone cone 23 may be found in the related descriptions of FIG. 1.

In some embodiments, the aerated intermediate ore slurry may enter the separation chamber 20 from the third inlet C1 of the intermediate ore treatment pipeline to impinge on a slope surface of a cyclone cone 23 to form a cyclone. The cyclone is capable of promoting the aerated intermediate ore slurry to release the tiny bubbles, so as to strengthen the collision of the second mineral particles with the tiny bubbles, and promote the upward flotation of the low-density mineralized bubbles.

S4. Low-density unmineralized minerals in the middle region of the separation chamber 20 may be discharged as the intermediate ore slurry through the first outlet A2 of the raw ore treatment pipeline. High-density unmineralized minerals in a surrounding region of the separation chamber 20 may form tailings to be discharged through the tailings discharge pipe 22. The operations S1-S3 may be repeated, the mineralized bubbles may continue to form stable concentrate froth at a top of the separation chamber 20, and the concentrate froth may overflow to be collected.

The low-density unmineralized minerals are minerals formed from the low-density unmineralized particles. The high-density unmineralized minerals are minerals formed from the high-density unmineralized particles.

In some embodiments, the intermediate ore slurry may enter the mineralization cylinder 30 from the second inlet B1 of the vortex mineralization pipeline, and the intermediate ore slurry may enter the mineralization cylinder through at least two inlet pipelines 400 disposed opposite each other in the form of an impinging stream.

More descriptions regarding the inlet pipelines 400 and the impinging stream may be found in the related descriptions of FIG. 1, FIG. 2, and FIG. 6.

In some embodiments, the concentrate froth may be collected by the concentrate collection device 60 disposed at an overflow opening of the top of the separation chamber 20 and discharged through the concentrate discharge opening 621 disposed at the bottom plate 62 of the concentrate collection device 60.

After the mineralized bubbles continue to form the stable concentrate froth at the top of the separation chamber 20, the flushing system 70 may be opened, and the concentrate froth may overflow into the collection tank body 61 of the concentrate collection device 60, and flow towards the concentrate discharge opening 621 along the inclined bottom plate 62. The concentrate froth on the inclined bottom plate 62 may be flushed to be discharged by the flushing system 70, and a target concentrate may be obtained and discharged from the concentrate discharge opening 621.

More descriptions regarding the concentrate collection device 60 and the flushing system 70 may be found in the related descriptions of FIG. 1.

S5. After separation flotation is completed, feeding of the first inlet A1 of the raw ore treatment pipeline may be stopped, the tailings discharge pipe 22 may be closed, a power device may be turned off, and the ore discharge pipe 36 may be opened to discharge a residual slurry in the separation chamber 20 and the mineralization cylinder 30. In response to determining that a liquid level in the mineralization cylinder 30 is lower than an inlet height of each of the one or more air conduits 31, the one or more air conduits 31 may be closed, the circulation pump 10 may be turned off after the residual slurry in the separation chamber 20 is discharged completely, and the ore discharge pipe 36 may be closed after all discharges are completed.

The residual slurry is an excess slurry remaining in the separation chamber 20 and the mineralization cylinder 30 after the separation flotation is completed. The residual slurry may include the residual raw ore slurry, the residual intermediate ore slurry, the residual aerated intermediate ore slurry, or the like.

When the inlet of the vortex mineralization pipeline is provided with the slurry distribution tank 40, and the third inlet C1 of the intermediate ore treatment pipeline is connected with the intermediate ore recirculation feed chute 50, the operation process remains constant, and only the circulation process of the slurry is increased by the distribution process of the slurry distribution tank 40/the intermediate ore recirculation feed chute 50, which is not repeated here.

In some embodiments, the vortex mineralization-static separation flotation method may further include: obtaining concentrate flotation amounts discharged from the concentrate discharge opening 621 at a plurality of consecutive time points to obtain a first change situation; obtaining raw ore feed rates of the raw ore treatment pipeline at the plurality of consecutive time points to obtain a second change situation; and determining, based on the first change situation and the second change situation, a target circulation power and a target raw ore feed rate to dynamically regulate a circulation power of the circulation pump and the raw ore feed rate. The first change situation characterizes a change in the concentrate flotation amount; and the second change situation characterizes a change in the raw ore feed rate.

In some embodiments, the processor may obtain, through a second pressure sensor, the concentrate flotation amounts discharged from the concentrate discharge opening 621 at the plurality of the consecutive time points, and generate a concentrate flotation amount sequence; and obtain the raw ore feed rates of the raw ore treatment pipeline at the plurality of the consecutive time points, and generate a raw ore feed rate sequence.

The concentrate flotation amount is an amount of concentrate collected after separation flotation. The concentrate flotation amount may be positively correlated with a discharge pressure. The higher the discharge pressure, the more concentrate is collected. The discharge pressure is a pressure at the concentrate discharge opening 621. The discharge pressure may be obtained by the second pressure sensor. For example, the concentrate flotation amount may be expressed as the pressure at the concentrate discharge opening 621. In some embodiments, the processor may obtain the discharge pressure through the second pressure sensor, and use the obtained discharge pressure as the concentrate flotation amount. The concentrate flotation amount sequence is a sequence of data consisting of a plurality of concentrate flotation amounts. In some embodiments, the processor may use a preset count of time points prior to the current moment as the plurality of consecutive time points. The preset count may be set based on experience. For example, the preset count may be greater than 3. An interval of the consecutive time points may be set according to demand. For example, the interval of the consecutive time points may be 5 min, 10 min, or the like. The concentrate flotation amount sequence may be expressed as a vector. For example, the concentrate flotation amount sequence may be expressed as (P1, P2, P3, . . . , Pn), where n denotes the preset count, and Pn denotes a concentrate flotation amount at an nth time point.

For example, the preset count may be 10, and the processor may obtain the concentrate flotation amounts at the current moment and 9 consecutive time points before the current moment as the concentrate flotation amount sequence.

The raw ore feed rate is a feed rate at which the raw ore slurry enters the separation chamber 20. For example, the raw ore feed rate may be 0.2 tons per minute. The raw ore feed rate sequence is a sequence consisting of a plurality of raw ore feed rates. The raw ore feed rate sequence may be expressed as a vector. In some embodiments, the first inlet A1 may be provided with a speed sensor. The processor may use a preset count of time points before the current moment as the plurality of the consecutive time points, and obtain the raw ore feed rates at the plurality of consecutive time points based on the speed sensor as the raw ore feed rate sequence.

The circulation power of the circulation pump is an operation power during operation of the circulation pump 10. The higher the operation power, the faster the slurry circulates. The raw ore feed rate may be regulated by a first solenoid valve. The bigger the valve opening of the first solenoid valve, the faster the raw ore feed rate. The target circulation power is a target value for regulating the operation power of the circulation pump 10. The target raw feed rate is a target value for regulating the raw ore feed rate.

In some embodiments, the processor may determine change rates of the plurality of consecutive time points based on the concentrate flotation amount sequence; and determine the first change situation based on the change rates of the plurality of consecutive time points. The processor may calculate the change rates of the plurality of consecutive time points based on the concentrate flotation amounts at the consecutive time points. For example, the change rate of the consecutive time point=(a concentrate flotation amount at t2-a concentrate flotation amount at t1)/the concentrate flotation amount at t1; where t1 and t2 denote the consecutive time points.

In some embodiments, the processor may determine the first change situation based on a statistical value of the change rates at the plurality of consecutive time points. The statistical value may be a sum of the change rates of the plurality of consecutive time points. If the sum of the change rates of the plurality of consecutive time points is greater than 0, the first change situation is an increase in the change rate of the concentrate flotation amount. If the sum of the change rates of the plurality of consecutive time points is less than 0, the first change situation is a decrease in the change rate of the concentrate flotation amount. If the sum of the change rates of the plurality of consecutive time points is 0, the first change situation is that the change rate of the concentrate flotation amount remains constant.

Merely by way of example, if the concentrate flotation amount sequence includes change rates at 10 consecutive time points, the change rate at each consecutive time point is calculated to be 2%, −1%, 3%, −2%, 4%, −3%, 1%, −1%, −1%, −1%, and 0% respectively, and an overall change rate is 2%, the change rate of the concentrate flotation amount is an increase.

The second change situation reflects an overall change rate of the raw ore feed rate sequence. To ensure stability, the raw ore feed rate does not need to be regulated frequently, so the second change situation selects values of two endpoints of the raw ore feed rate sequence for comparison. The processor may determine the second change situation based on a difference between a raw ore feed rate at an initial time point and a raw ore feed rate at a current time point in the raw ore feed rate sequence. If the difference is greater than 0, the second change rate is an increase in the change rate of the raw ore feed rate. If the difference is less than 0, the second change rate is a decrease in the change rate of the raw ore feed rate.

In some embodiments, the processor may determine the target circulation power and the target raw ore feed rate based on the first change situation and the second change situation through a preset rule, and dynamically regulate the circulation power of the circulation pump and the raw ore feed rate.

The preset rule may be set based on experience. For example, the preset rule may include keeping a current circulation power and a current raw ore feed rate constant in response to an increase in the change rate of the concentrate flotation amount. The increase in the change rate of the concentrate flotation amount indicates that the obtained concentrate is increased, and the flotation effect is good with no adjustment of parameters. As another example, the preset rule may include keeping the current circulation power and the raw ore feed rate in response to the change rate of the concentrate flotation amount remaining constant and the raw ore feed rate decreasing. The same concentrate being obtained despite a decrease in the raw ore feed rate indicates that the flotation effect is good with no adjustment of parameters.

As another example, the preset rule may include increasing the circulation power by A in response to a decrease in the change rate of the concentrate flotation amount and constant raw ore feed rate to obtain the target circulation power. In the case where more impurities in the raw ore reduce the flotation effect, increasing the cycling power may further improve the flotation effect. As another example, the preset rule may include increasing the circulation power by B in response to a decrease in the change rate of the concentrate flotation amount and an increase in the raw ore feed rate to obtain the target circulation power, where B may be greater than A. The change rate of the concentrate flotation amount still decreases when the raw ore feed rate increases, indicating that the flotation effect is even lower, and the circulation power needs to be further improved. As another example, the preset rule may include increasing the circulation power by A in response to a decrease in the change rate of the concentrate flotation amount and a decrease in the raw ore feed rate to obtain the target circulation power, and increasing the raw ore feed rate to obtain the target raw ore feed rate. Both the change rate of the concentrate flotation amount and the raw ore feed rate decrease, indicating that the current flotation effect is unsatisfactory, the raw ore feed rate and the circulation power may be increased simultaneously, and the sequent first change situation and the second change situation may be further observed.

In some examples, the processor may control the circulation pump to operate at the target circulation power and the first solenoid valve to operate at the target raw ore feed rate.

If the concentrate flotation amount changes, the resulting intermediate ore slurry and tailings also change. Dynamic regulation of the circulation power of the circulation pump and the raw ore feed rate can ensure that the processing efficiency of the static separator and the vortex mineralizer is corresponding, so as to avoid a decline in the flotation quality caused by failure of cooperative operation of two devices due to a fluctuation of pulp composition, an environmental impact, or other factors.

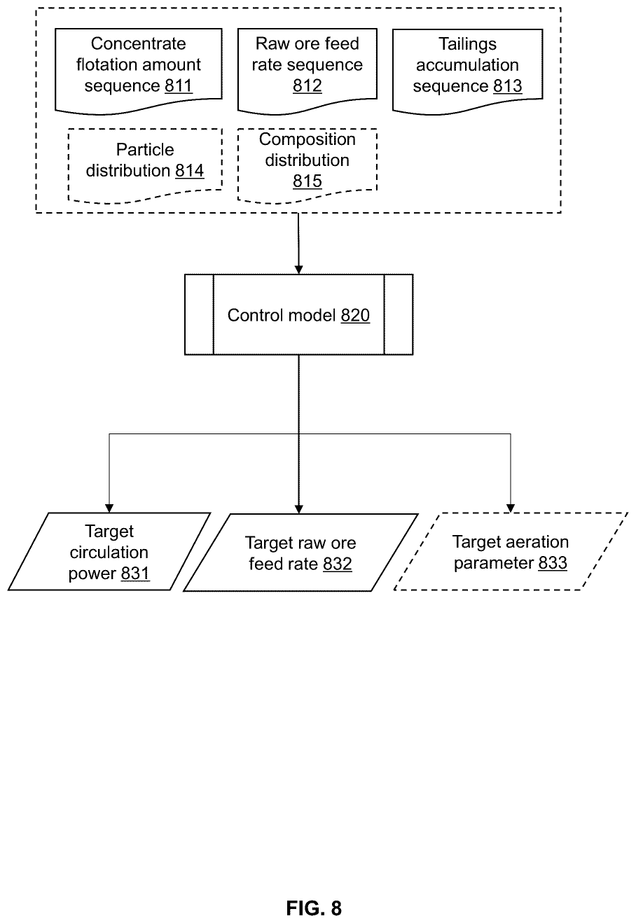

FIG. 8 is a schematic diagram illustrating an exemplary control model according to some embodiments of the present disclosure.

In some embodiments, as shown in FIG. 8, a processor may determine, based on a concentrate flotation amount sequence 811, a raw ore feed rate sequence 812, and a tailings accumulation sequence 813 at a plurality of consecutive time points, a target circulation power 831 and a target raw ore feed rate 832 through a control model 820.

Tailings accumulation is accumulation of tailings at the tailings discharge pipe 22. The tailings accumulation sequence 813 is a sequence parameter consisting of a plurality of tailings accumulations. In some embodiments, the processor may obtain a plurality of tailings accumulations at the plurality of consecutive time points through a first pressure sensor to form the tailings accumulation sequence 813. More descriptions regarding the plurality of consecutive time points, the concentrate flotation amount sequence, the raw ore feed rate sequence, the target circulation power, and the target raw ore feed rate may be found in the present disclosure above. More descriptions regarding the first pressure sensor may be found in the related descriptions of FIG. 1.

The control model 820 is a model for determining the target circulation power and the target raw ore feed rate. In some embodiments, the control model 820 may be a machine learning model. For example, the control model 820 may be a deep neural networks (DNN) model, or the like, or any combination thereof.

An input of the control model 820 may include the concentrate flotation amount sequence 811, the raw ore feed rate sequence 812, and the tailings accumulation sequence 813, or the like, and an output of the control model 820 may include the target circulation power 831, the target raw ore feed rate 832, or the like.

In some embodiments, the control model may obtained by training a large number of first training samples and first labels corresponding to the first training samples. In some embodiments, the plurality of first training samples with the first labels may be input into an initial control model. A loss function may be constructed from the first labels and results of the initial control model. Parameters of the initial control model may be iteratively updated by gradient descent or other methods based on the loss function. The model training may be completed when a preset condition is satisfied, and a trained control model may be obtained. The preset condition may be that the loss function converges, or a count of iterations reaches a threshold, or the like.

The first training samples may include a sample concentrate flotation amount sequence, a sample raw ore feed rate sequence, and a sample tailings accumulation sequence. The first training samples may be obtained from historical data. In some embodiments, the processor may select historical data of which an average value of historical concentrate flotation amount sequences is greater than a preset flotation threshold and an average value of historical tailings accumulation sequences is less than a preset accumulation threshold from the historical data corresponding to a plurality of historical moments as the first training samples, and use historical circulation powers and historical raw ore feed rates of the historical moments corresponding to the first training samples as the first labels. The average of the historical concentrate flotation amount sequences refers to an average value of historical concentrate flotation amounts corresponding to the plurality of historical consecutive time points in the historical data. The average value of the historical tailings accumulation sequences is an average value of historical tailings accumulations corresponding to the plurality of historical consecutive time points in the historical data. The processor may determine the average value of the historical concentrate flotation amount sequences and the average value of the historical tailings accumulation sequences through calculation. The preset flotation threshold and the preset accumulation threshold may be set based on experience.

By increasing the circulation power of the circulation pump, the impact force of the slurry can be increased and the accumulation of the tailings at the bottom of the mineralization cylinder can be slowed down. However, over-increasing the circulation power of the circulation pump may bring more tailings. The target circulation power and the target raw ore feed rate can be comprehensively determined through the control model, so as to make the dynamic regulation process more reasonable, and thus improve the flotation quality.

In some embodiments, the input of the control model 820 may further include a particle distribution 814 of the raw ore slurry and a composition distribution 815 of the raw ore slurry. The first training samples of the control model may further include a sample particle distribution and a sample composition distribution of a sample raw ore slurry. The first training samples may be obtained from the historical data. The historical data may include historical particle distributions and historical composition distributions of the raw ore slurry.

The particle distribution of the raw ore slurry may reflect a distribution of mineral particles of different physical properties in the raw ore slurry. The composition distribution of the raw ore slurry reflects a distribution of mineral particles of different compositions in the raw ore slurry. In some embodiments, the particle distribution and the composition distribution of the raw ore slurry may be measured by experiments. The particle distributions and the composition distributions corresponding to different raw ore slurries may be different. If the raw ore slurry is replaced, the particle distribution and the composition distribution of the raw ore slurry need to be measured by experiments again.

For the raw ore slurries with different particle distributions and/or composition distributions, to obtain the same concentrate flotation amount, the corresponding target circulation power, and the target raw ore feed rate may be different. Therefore, considering the particle distribution and the composition distribution of the raw ore slurry can make the output results of the control model more accurate, thereby further improving the flotation quality.

In some embodiments, the output of the control model 820 may further include a target aeration parameter 833.

The aeration parameter is a parameter related to air injection. In some embodiments, the aeration parameter may include agitation speeds of the mineralization impeller and the dispersion circulation impeller, air jet speeds of the one or more air conduits, or the like. The processor may obtain a rotation speed of a power device (e.g., the drive motor 37 in FIG. 1) as the agitation speeds of the mineralization impeller and the dispersion circulation impeller. The processor may obtain a power of an air pump of each air conduit, and determine the air jet speed of each air conduit based on the power of the air pump. For example, the air jet speed may be positively correlated with the power of the air pump. More descriptions regarding the drive motor and the air pump may be found in FIG. 1. The target aeration parameter is an aeration parameter after dynamic regulation.

In some embodiments, the first labels of the control model may further include historical aeration parameters corresponding to the historical moments corresponding to the first training samples. For example, the control model may use historical agitation speeds of the mineralization impeller and the dispersion circulation impeller and historical air jet speeds of the one or more air conduits at the historical moments corresponding to the first training samples, or the like, as the first labels.

The aeration parameter affects the efficiency of the mineralization and collision of the tiny bubbles with the slurry, which in turn affects the flotation quality. Therefore, the flotation quality after regulation can be further improved by considering the output target aeration parameter and performing dynamic regulation.

In some embodiments, the processor may obtain slurry flow rates at the plurality of consecutive time points; determine an accumulation speed of the residual slurry based on the slurry flow rates, the particle distribution of the raw ore slurry, and the composition distribution of the raw ore slurry; and in response to determining that the accumulation speed satisfies a preset accumulation condition, control to open an ore discharge pipe by a second solenoid valve to discharge the accumulated residual slurry.

In some embodiments, the processor may obtain the slurry flow rates at the plurality of consecutive time points to generate a slurry flow rate sequence.

The slurry flow rate is a flow rate of the slurry in the mineralization cylinder. The slurry flow rate sequence is a sequence of data consisting of a plurality of slurry flow rates. The slurry flow rate sequence may be expressed as a vector. In some embodiments, the processor may obtain the slurry flow rates at the plurality of consecutive time points based on a flow meter at the second inlet B1 and/or the second outlet B2 of the vortex mineralization pipeline to generate the slurry flow rate sequence. The accumulation speed of the residual slurry is an accumulation speed of a residue in the mineralization cylinder at the ore discharge pipe. For example, the accumulation speed of the residual slurry may be 0.02 tons per hour. More descriptions regarding the plurality of consecutive time points, the particle distribution of the raw ore slurry, and the composition distribution of the raw ore slurry may be found in the related descriptions of FIGS. 7-9.

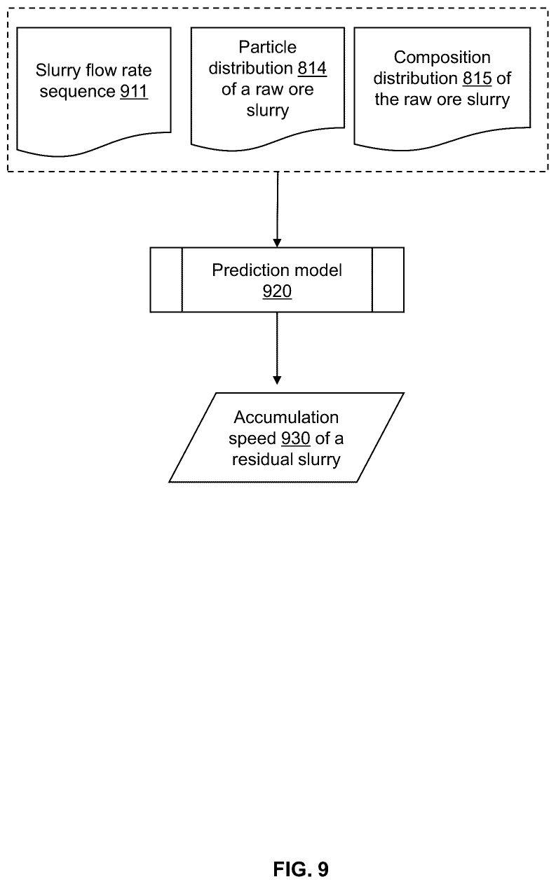

FIG. 9 is a schematic diagram illustrating an exemplary prediction model according to some embodiments of the present disclosure.

In some embodiments, as illustrated in FIG. 9, a processor may predict an accumulation speed 930 of a residual slurry through a prediction model 920 based on a slurry flow rate sequence 911, a particle distribution 814 of a raw ore slurry, and a composition distribution 815 of the raw ore slurry.

The prediction model 920 is a model for determining the accumulation speed 930 of the residual slurry. In some embodiments, the prediction model 920 may be a machine learning model. For example, the prediction model 920 may be a DNN model, or the like, or any combination thereof.

An input of the prediction model 920 may include the slurry flow rate sequence 911, the particle distribution 814 of the raw ore slurry, and the composition distribution 815 of the raw ore slurry, or the like, and an output of the prediction model 920 may include the accumulation speed 930 of the residual slurry, or the like.

In some embodiments, the prediction model may be obtained by training a large number of second training samples and second labels corresponding to the second training samples. In some embodiments, the plurality of the second training samples with the second labels may be input into an initial prediction model, and the prediction model may be obtained by a training mode similar to the training process of the control model. More descriptions regarding the training process of the control model may be found in the related descriptions of FIG. 8.

The second training samples may include a sample slurry flow sequence, a sample particle distribution of a sample raw ore slurry, and a sample composition distribution of the sample raw ore slurry. The second training samples may be obtained from historical data. The historical data may include historical discharge residual slurry amounts. The processor may determine historical residual slurry accumulation speeds based on the historical discharge residual slurry amounts corresponding to the second training sample in the historical data, and use the historical residual slurry accumulation speeds as the second labels. For example, the historical residual slurry accumulation speeds=the historical discharge residual slurry amounts #historical accumulation time. The historical discharge residual slurry amounts may be obtained by manually weighing the residual slurry discharged from the ore discharge pipe. The historical accumulation time may be a historical interval duration between two discharges of the residual slurry from the ore discharge pipe.

In some embodiments, the preset accumulation condition may be the residual slurry accumulation exceeding a preset accumulation threshold. The preset accumulation threshold may be set based on experience.

The residual slurry accumulation is a predicted accumulation of the residual slurry at the ore discharge pipe at the current moment. In some embodiments, the processor may determine the residual slurry accumulation based on the accumulation speed and the accumulation time of the residual slurry in various ways. The residual slurry accumulation may be positively correlated with the accumulation speed and the accumulation time of the residual slurry. For example, the residual slurry accumulation=the accumulation speed x the accumulation time of the residual slurry, where the accumulation speed of the residual slurry is the output result of the prediction model. The accumulation time is a time interval between the moment when the ore discharge pipe performs the last discharge and the current moment.

In some embodiments, in response to determining that the residual slurry accumulation exceeds the preset accumulation threshold, the processor may control the second solenoid valve to operate at a maximum speed, such that the ore discharge pipe rapidly discharges the accumulated residual slurry.

The residue in the mineralization cylinder may include the residual slurry of the raw ore slurry, and tailings particles coming in from the second inlet B1 (it is not possible for the static separator to remove 100% of the tailings particles). Due to different flow rates of liquids and solids contained in the mineralization cylinder, the residual slurry accumulation fluctuates so much that direct measurement is not able to obtain an accurate value. Predicting the accumulation speed of the residual slurry through the prediction model, and predicting the slurry accumulation based on the accumulation speed can improve the accuracy of prediction and open the ore discharge pipe in time to discharge the excess slurry buildup.

In some embodiments, the processor may adjust oscillation speeds of the at least two inlet pipelines 400 based on the accumulation speed of the residual slurry.

The oscillation speeds of the at least two inlet pipeline 400 are speeds (i.e., change speeds of the inclination angles) at which the at least two inlet pipelines 400 of the mineralization cylinder 30 oscillate. The oscillation speed may be positively correlated with the accumulation speed of the residual slurry. The larger the accumulation speed of the residual slurry, the larger the oscillation speed.

The processor may control cylinders of the at least two inlet pipelines 400 to control deformation degrees of two sides of a corrugated pipe, so as to cause the inclination angles of the at least two inlet pipelines 400 to change to achieve oscillation. The at least two inlet pipelines 400 may oscillate cyclically within a limit of a preset maximum angle. The preset maximum angle is a maximum value of the inclination angles of the at least two inlet pipelines 400 in a horizontal direction relative to an outer wall of the mineralization cylinder 30.

By adjusting the oscillation speeds of the at least two inlet pipelines, the tailings accumulation can be further slowed down to avoid dead ends of accumulation. Meanwhile, when the accumulated slurry is discharged through the ore discharge pipe (e.g., when the tailings are accumulated high), increasing the oscillation speeds of the at least two inlet pipelines can improve the discharge efficiency, thereby avoiding accumulation of the solid slurry in the mineralization cylinder.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. In some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A vortex mineralization-static separation flotation device, comprising a static separator provided with a separation chamber and a vortex mineralizer provided with a mineralization cylinder, wherein the separation chamber is provided with a raw ore treatment pipeline from top to bottom and an intermediate ore treatment pipeline from bottom to top, the mineralization cylinder is provided with a vortex mineralization pipeline from bottom to top;
a first outlet of the raw ore treatment pipeline is connected with a second inlet of the vortex mineralization pipeline, and a second outlet of the vortex mineralization pipeline is connected with a third inlet of the intermediate ore treatment pipeline.

2. The vortex mineralization-static separation flotation device of claim 1, wherein the second inlet of the vortex mineralization pipeline is connected with one or more air conduits;
the second inlet of the vortex mineralization pipeline is provided on a bottom side wall of the mineralization cylinder, the first outlet of the raw ore treatment pipeline is connected with the second inlet through one or more inlet pipelines, and the vortex mineralization pipeline includes at least two of the one or more inlet lines disposed opposite to each other.

3. The vortex mineralization-static separation flotation device of claim 2, wherein each of the one or more inlet pipelines includes a slurry distribution tank and a slurry distribution pipe, wherein the slurry distribution tank is provided around a top side wall of the mineralization cylinder, the slurry distribution tank is connected with the slurry distribution pipe provided vertically, a count of the slurry distribution pipes matches a count of the one or more inlet pipelines;
a lining jet pipe is provided at a connection end between the slurry distribution pipe and the slurry distribution tank, and the one or more air conduits are connected with a side of the slurry distribution pipe close to the lining jet pipe.

4. The vortex mineralization-static separation flotation device of claim 3, wherein an agitation device is disposed in the mineralization cylinder, the agitation device including a mineralization impeller configured to generate a vortex, and the mineralization impeller being disposed above the second inlet.

5. The vortex mineralization-static separation flotation device of claim 1, wherein a first inlet of the raw ore treatment pipeline is disposed above the separation chamber, the first inlet is connected with a feed pipe, a discharge end of the feed pipe extends towards the inside of the separation chamber and bends towards a bottom of the separation chamber; and a mouth of the discharge end of the feed pipe is closed, and a pipe wall of the discharge end is provided with one or more through holes.

6. The vortex mineralization-static separation flotation device of claim 5, wherein the third inlet of the intermediate ore treatment pipeline is disposed on a bottom side wall of the separation chamber, a cyclone cone is disposed in the separation chamber, a side wall of the cyclone cone is a slope surface, the third inlet is disposed opposite to the slope surface;
the third inlet is provided with one or more cyclone pipes, and the one or more cyclone pipes are disposed at a preset deflection angle towards the cyclone cone.

7. The vortex mineralization-static separation flotation device of claim 6, wherein the intermediate ore treatment pipeline includes an intermediate ore recirculation feed chute and at least one intermediate ore distribution pipe disposed around the separation chamber, wherein the intermediate ore recirculation feed chute is disposed close to a bottom of the first inlet of the raw ore treatment pipeline, the intermediate ore recirculation feed chute is connected with the third inlet through the intermediate ore distribution pipe;
an outlet of the intermediate ore distribution pipe is connected with the one or more cyclone pipes, and the one or more cyclone pipes are disposed at the same deflection angle towards the cyclone cone.

8. The vortex mineralization-static separation flotation device of claim 6, wherein the cyclone cone is a conical cylinder through a vertical direction, an inner diameter of the bottom of the cyclone cone matches an inner diameter of the separation chamber;
the vortex mineralization-static separation flotation device comprises a tailings discharge pipe, the tailings discharge pipe and the first outlet of the raw ore treatment pipeline being disposed below the bottom of the cyclone cone; wherein
the bottom of the separation chamber is a slope inclined towards the tailings discharge pipe;
an intermediate ore inverted cone is disposed at the bottom of the separation chamber, the intermediate ore inverted cone is a cone with an opening towards a bottom of the conical cylinder, and the first outlet of the raw ore treatment pipeline is disposed on a side wall of the intermediate ore inverted cone; and
a stop cover is disposed at the opening of the intermediate ore inverted cone, and the stop cover is in clearance connection with an upper edge of the intermediate ore inverted cone.

9. The vortex mineralization-static separation flotation device of claim 1, wherein one or more horizontally arranged sieve plates are disposed in the separation chamber, a size of each of the one or more sieve plates matches the inner diameter of the separation chamber, and penetration circular holes are uniformly disposed in the one or more sieve plates;
the one or more sieve plates separate the separation chamber into interconnected partitions, the one or more sieve plates include at least a first sieve plate, a second sieve plate, and a third sieve plate, the first sieve plate is disposed above the first inlet of the raw ore treatment pipeline, the second sieve plate is disposed below the first inlet, the third sieve plate is disposed above the third inlet of the intermediate ore treatment pipeline; and a static separation region of the separation chamber is formed between the second sieve plate and the third sieve plate.

10. The vortex mineralization-static separation flotation device of claim 4, wherein two horizontally oriented circular plates are disposed in the vortex mineralizer, and edges of the two circular plates are closely connected with an inner wall of the mineralization cylinder;
the two circular plates include a first circular plate and a second circular plate, the first circular plate being disposed between the second inlet of the vortex mineralization pipeline and the mineralization impeller to form an impinging stream mineralization chamber for an intermediate ore slurry with a bottom of the mineralization cylinder; the second circular plate is disposed below the second outlet of the vortex mineralization pipeline to form a discharge chamber for the intermediate ore slurry with a top of the mineralization cylinder.

11. The vortex mineralization-static separation flotation device of claim 10, wherein the agitation device further includes a dispersion circulation impeller, the dispersion circulation impeller is disposed below the second circular plate, a central circular plate is disposed between the dispersion circulation impeller and the mineralization impeller, a dispersion circulation mineralization chamber is formed between the central circular plate and the second circular plate, a vortex forced mineralization chamber is formed between the central circular plate and the first circular plate;
a diameter of a center hole of the first circular plate is less than or equal to a blade diameter of the mineralization impeller, and diameters of center holes of the central circular plate and the second circular plate are both greater than the blade diameter of the mineralization impeller and a blade diameter of the dispersion circulation impeller.

12. The vortex mineralization-static separation flotation device of claim 11, wherein a plurality of circumferentially distributed baffles are disposed on a top surface of the first circular plate and a bottom surface of the second circular plate, a long side of each of the plurality of baffles abuts against the inner wall of the mineralization cylinder, a width of each of the plurality of baffles is less than a circular ring width of each of the circular plates;
the plurality of baffles disposed on the top surface of the first circular plate extend upwardly to a position beyond a top surface of the mineralization impeller, and the plurality of baffles disposed on the bottom surface of the second circular plate extend downwardly to a position beyond a bottom surface of the dispersion circulation impeller; and
one or more circumferentially arranged liner plates are disposed on a bottom surface and a top surface of the central circular plate, a long side of each of the one or more liner plates abuts against the inner wall of the mineralization cylinder, and a width of each of the one or more liner plates is less than a circular ring width of the central circular plate.

13. The vortex mineralization-static separation flotation device of claim 2, wherein the top of the mineralization cylinder is sealed by a sealing cover plate, and an ore discharge pipe is disposed at the bottom of the mineralization cylinder;
the vortex mineralizer is connected with a power device, the power device is disposed on the sealing cover plate, and the power device is electrically connected with agitation device.

14. The vortex mineralization-static separation flotation device of claim 1, comprising a concentrate collection device, wherein the concentrate collection device is disposed above a top of the separation chamber, and an overflow opening is disposed at the top of the separation chamber;
the concentrate collection device includes a collection tank body of which an inner diameter is greater than an outer diameter of the separation chamber, a bottom of the collection tank body is provided with a groove matching a size of the overflow opening, and the concentrate collection device is sleeved and fixed on a top outer side of the separation chamber; and
a bottom plate of the collection tank body is provided with a concentrate discharge opening, and the bottom plate is inclined towards a direction of the concentrate discharge opening.

15. The vortex mineralization-static separation flotation device of claim 14, wherein the concentrate collection device further includes a flushing system, the flushing system includes a flushing water ring and a water inlet pipe connected with the flushing water ring; the flushing water ring is provided in a circle along a columnar inner side wall of the concentrate collection device, at least one flushing water outlet is disposed on the flushing water ring, and the at least one flushing water outlet faces the bottom plate.

16. The vortex mineralization-static separation flotation device claim 1, wherein a circulation pump is disposed between the first outlet of the raw ore treatment pipeline and the second inlet of the vortex mineralization pipeline.

17. A vortex mineralization-static separation flotation method, comprising:
S1. closing a tailings discharge pipe disposed at a bottom of a separation chamber, a raw ore slurry entering the separation chamber from a first inlet of a raw ore treatment pipeline and being discharged through a first outlet, the raw ore slurry entering a mineralization cylinder from a second inlet of a vortex mineralization pipeline, and when the mineralization cylinder is full of the raw ore slurry, the raw ore slurry being discharged from a second outlet of the vortex mineralization pipeline and entering the separation chamber again from a third inlet of an intermediate ore treatment pipeline;
S2. in response to determining that the raw ore slurry in the separation chamber reaches a set level, turning on one or more air conduits, an agitation device, and the tailings discharge pipe to make air enter the mineralization cylinder and form tiny bubbles to collide with first mineral particles and mineralize to form an aerated intermediate ore slurry;
S3. the aerated intermediate ore slurry entering the separation chamber through the third inlet of the intermediate ore treatment pipeline, the tiny bubbles being released to collide with second mineral particles in the separation chamber to mineralize, low-density mineralized bubbles moving towards a center of the separation chamber and floating upwardly, unmineralized bubbles descending, and the low-density mineralized bubbles performing countercurrent collision with the raw ore slurry entering the separation chamber for mineralization;
S4. low-density unmineralized minerals in a middle region of the separation chamber being discharged as an intermediate ore slurry through the first outlet of the raw ore treatment pipeline, high-density unmineralized minerals in a surrounding region of the separation chamber forming tailings to be discharged through the tailings discharge pipe, repeating S1-S3, the mineralized bubbles continuing to form stable concentrate froth at a top of the separation chamber, and the concentrate froth overflowing to be collected; and
S5. after separation flotation is completed, stopping feeding of the first inlet of the raw ore treatment pipeline, closing the tailings discharge pipe, turning off a power device, and opening an ore discharge pipe to discharge a residual slurry in the separation chamber and the mineralization cylinder, in response to determining that a liquid level in the mineralization cylinder is lower than an inlet height of each of the one or more air conduits, closing the one or more air conduits, turning off a circulation pump after the residual slurry in the separation chamber is discharged completely, and closing the ore discharge pipe after all discharges are completed.

18. The vortex mineralization-static separation flotation method of claim 17, wherein in the operation S3, the aerated intermediate ore slurry enters the separation chamber from the third inlet of the intermediate ore treatment pipeline to impinge on a slope surface of a cyclone cone to form a cyclone.

19. The vortex mineralization-static separation flotation method of claim 17, wherein in the operation S4, the intermediate ore slurry enters the mineralization cylinder from the second inlet of the vortex mineralization pipeline, and the intermediate ore slurry enters the mineralization cylinder from at least two of one or more inlet lines disposed opposite each other in the form of an impinging stream.

20. The vortex mineralization-static separation flotation method of claim 17, wherein in the operation S4, the concentrate froth is collected by a concentrate collection device disposed at an overflow opening of a top of the separation chamber and discharged through a concentrate discharge opening disposed at a bottom plate of the concentrate collection device.
